(19) United States
(12) Patent Application Publication
(10) Pub. No.: US 2026/0200758 A1
(43) Pub. Date: Jul. 16, 2026

(54) METHOD FOR PREPARING CATHODE ACTIVE MATERIAL PRECURSOR AND CATHODE ACTIVE MATERIAL PRECURSOR

(71) Applicant: SK ON CO., LTD., Seoul (KR)

(72) Inventors: Hyung Joo NOH, Daejeon (KR); Chan Ho KIM, Daejeon (KR); Byoung Ki SON, Daejeon (KR); Duck Chul HWANG, Daejeon (KR)

(21) Appl. No.: 19/449,448

(22) Filed: Jan. 15, 2026

(30) Foreign Application Priority Data
Jan. 16, 2025 (KR) 10-2025-0006914

(51) Int. Cl. C01G 53/84

(52) U.S. Cl. CPC C01G 53/84; C01P 2004/03; C01P 2004/51; C01P 2004/84; C01P 2006/40

(57) ABSTRACT

According to the method for preparing a cathode active material precursor of the present disclosure, a core dispersion including a core that contains a metal hydroxide is prepared. A core-shell particle dispersion is prepared by dividing and introducing the core dispersion into a plurality of shell growth reactors to grow a shell from the surface of the core. An aqueous NaOH solution is introduced into the core-shell particle dispersion to increase its pH to 12.5 or more.

### CROSS-REFERENCE TO RELATED APPLICATION

This patent application claims priority to and the benefit of Korean Patent Application No. 10-2025-0006914 filed on Jan. 16, 2025, and all the benefits accruing therefrom under 35 U.S.C. § 119, the content of which is incorporated by reference herein in its entirety.

### BACKGROUND OF THE INVENTION

### 1. Field of the Invention

The present disclosure relates to a method for preparing a cathode active material precursor and a cathode active material precursor prepared thereby.

### 2. Description of the Related Art

Secondary batteries are batteries that can be repeatedly charged and discharged. With the development of information and communication and display industries, they have been widely applied as power sources for portable electronic communication devices, such as camcorders, mobile phones, and laptop PCs. In addition, battery packs including secondary batteries have recently been developed and applied as power sources for eco-friendly vehicles, such as hybrid vehicles.

Examples of secondary batteries may include a lithium secondary battery, a nickel-cadmium battery, and a nickel-hydrogen battery. Among these, the lithium secondary battery has been actively developed and applied due to its high operating voltage, high energy density per unit weight, and advantages in charging speed and weight reduction.

The lithium secondary battery may include: an electrode assembly including a cathode, an anode, and a separator, and an electrolyte that impregnates the electrode assembly. The lithium secondary battery may further include, for example, a pouch-type outer case that accommodates the electrode assembly and the electrolyte.

It is desirable for a lithium secondary battery to have a high capacity and to maintain operational and storage stability under extremely high or low temperature environments. Therefore, the development of a cathode capable of achieving a high-capacity and high-stability lithium secondary battery is required.

### SUMMARY OF THE INVENTION

An object of the present disclosure is to provide a method for preparing a cathode active material precursor that offers improved productivity.

Another object of the present disclosure is to provide a cathode active material precursor prepared by the method.

According to a method for preparing a cathode active material precursor, a core dispersion including a core that contains a metal hydroxide is prepared. A core-shell particle dispersion is prepared by dividing and introducing the core dispersion into a plurality of shell growth reactors to grow a shell from the surface of the core. An aqueous NaOH solution is introduced into the core-shell particle dispersion to increase its pH to 12.5 or more.

According to exemplary embodiments, the pH of the core-shell particle dispersion may be increased to 12.5 to 13.5.

According to exemplary embodiments, the step of preparing the core dispersion may include introducing a core preparation aqueous solution including a metal precursor and NH₄OH into a core preparation reactor to react.

According to exemplary embodiments, the ratio of the molar concentration of NH₄OH to the molar concentration of the metal precursor in the core preparation aqueous solution may be 0.5 to 0.8.

According to exemplary embodiments, the core preparation aqueous solution may further include NaOH, and the ratio of the molar concentration of NaOH to the molar concentration of the metal precursor in the core preparation aqueous solution may be 1.5 to 2.

According to exemplary embodiments, the step of preparing the core-shell particle dispersion may include: dividing and introducing the core dispersion into the plurality of shell growth reactors, and introducing a shell growth aqueous solution including a metal precursor and NH₄OH to react.

According to exemplary embodiments, the ratio of the molar concentration of NH₄OH to the molar concentration of the metal precursor in the shell growth aqueous solution may be greater than the ratio of the molar concentration of NH₄OH to the molar concentration of the metal precursor in the core preparation aqueous solution.

According to exemplary embodiments, the shell growth aqueous solution further includes NaOH, and the ratio of the molar concentration of NaOH to the molar concentration of the metal precursor in the shell growth aqueous solution may be less than the ratio of the molar concentration of NaOH to the molar concentration of the metal precursor in the core preparation aqueous solution.

According to exemplary embodiments, the number of shell growth reactors may be 2 to 10.

According to exemplary embodiments, the step of preparing the core-shell particle dispersion may include: preparing a first preliminary core-shell particle dispersion by dividing and introducing the core dispersion into a plurality of first shell growth reactors to grow a first shell from the surface of the core; and preparing a core-shell particle dispersion by dividing and introducing the first preliminary core-shell particle dispersion into a plurality of second shell growth reactors to grow a second shell from the surfaces of the first preliminary core-shell particles.

According to exemplary embodiments, preparing the first preliminary core-shell particle dispersion may include dividing and introducing the core dispersion into a plurality of first shell growth reactors, and introducing a first shell growth aqueous solution including a metal precursor and NH₄OH to react.

According to exemplary embodiments, preparing the core-shell particle dispersion may include dividing and introducing the first preliminary core-shell particle dispersion into a plurality of second shell growth reactors, and introducing a second shell growth aqueous solution including a metal precursor and NH₄OH to react.

The ratio of the molar concentration of NH₄OH to the molar concentration of the metal precursor in the second shell growth aqueous solution may be greater than the ratio of the molar concentration of NH₄OH to the molar concentration of the metal precursor in the first shell growth aqueous solution.

According to exemplary embodiments, the first shell growth aqueous solution and the second shell growth aqueous solution may each further include NaOH. The ratio of the molar concentration of NaOH to the molar concentration of the metal precursor in the second shell growth aqueous solution may be less than the ratio of the molar concentration of NaOH to the molar concentration of the metal precursor in the first shell growth aqueous solution.

A cathode active material precursor according to the present disclosure may include: metal hydroxide particles including a core and a shell layer disposed on the surface of the core, wherein the ratio of the median particle diameter of the metal hydroxide particles to the median particle diameter of the core may be 1 to 4, and a sphericity of the metal hydroxide particles may be 0.8 to 1.

A cathode active material precursor according to the present disclosure may include: metal hydroxide particles including a core and a shell layer disposed on the surface of the core, wherein the ratio of the median particle diameter of the metal hydroxide particles to the median particle diameter of the core may be 1 to 4, and a span value of the metal hydroxide particles, defined by Equation 1, may be 0.6 or less:

Vₛₚₐₙ=(D90−D10)/D50 [Equation 1]

(in Equation 1, Vₛₚₐₙ denotes the span value, D90 denotes the particle diameter at the 90% point of the cumulative particle size distribution of the metal hydroxide particles, D10 denotes the particle diameter at the 10% point of the cumulative particle size distribution of the metal hydroxide particles, and D50 denotes the particle diameter at the 50% point of the cumulative particle size distribution of the metal hydroxide particles).

According to exemplary embodiments, the shell layer may include a plurality of rod-shaped primary particles, and at least some of the rod-shaped primary particles are oriented toward the center of the metal hydroxide particles.

According to exemplary embodiments, the content of nickel, based on the total molar amount of elements of the metal hydroxide particles excluding oxygen and hydrogen, may be 55 mol % to 99 mol %.

According to a method for preparing a cathode active material precursor according to exemplary embodiments of the present disclosure, the cathode active material precursor may be prepared through a multi-step process. The cathode active material precursor may include small core particles and a thick shell, thereby enabling a cathode active material with improved cycle life characteristics and crystal structure stability.

According to exemplary embodiments of the present disclosure, the method for preparing a cathode active material precursor may exhibit improved productivity, thereby increasing the amount of cathode active material precursor prepared per unit time.

The cathode active material precursor according to exemplary embodiments of the present disclosure may have high sphericity and a uniform particle size distribution, thereby enabling a cathode active material with improved cycle life characteristics.

The method for manufacturing a cathode active material according to exemplary embodiments of the present disclosure may enable a cathode active material with improved cycle life characteristics.

### BRIEF DESCRIPTION OF THE DRAWINGS

The above and other objects, features and advantages of the present disclosure will be more clearly understood from the following detailed description taken in conjunction with the accompanying drawings, in which:

FIG. 1 is a schematic view illustrating a system for preparing a cathode active material precursor according to an exemplary embodiment;

FIGS. 2 and 3 are schematic plan and cross-sectional views, respectively, illustrating a lithium secondary battery according to exemplary embodiments;

FIG. 4 is a scanning electron microscope (SEM) image of a cross-section of a cathode active material precursor prepared in Example 1; and

FIG. 5 is a scanning electron microscope (SEM) image of a cross-section of a cathode active material precursor prepared in Comparative Example 1.

### DETAILED DESCRIPTION OF THE INVENTION

The present disclosure provides a method for preparing a cathode active material precursor with high productivity. In addition, the present disclosure provides a cathode active material precursor prepared by the method and a cathode active material derived from the cathode active material precursor.

As used herein, the term “median particle diameter (D50)” may refer to the particle diameter value at which 50% of the volume-based cumulative distribution is reached. The volume-based cumulative distribution of the particles may be obtained based on a laser diffraction scattering method.

In this specification, a “secondary particle” may be a structure in which a plurality of primary particles (e.g., more than 10) are agglomerated to form a substantially single particle.

Hereinafter, exemplary embodiments of the present disclosure will be described in detail with reference to the accompanying drawings. However, these embodiments are merely illustrative, and the present disclosure is not limited to the specific embodiments described as examples.

FIG. 1 is a schematic view illustrating a system for preparing a cathode active material precursor according to an exemplary embodiment. FIG. 1 schematically illustrates a multi-stage reaction capable of preparing a cathode active material precursor.

According to the method for preparing a cathode active material precursor of the present disclosure, a core including a metal hydroxide is prepared. For example, a core dispersion including the core is prepared.

For example, the core dispersion may be prepared in a core preparation reactor (C1 in FIG. 1). The core preparation reactor may be a continuous stirred-tank reactor (CSTR) or a batch reactor (BR). For example, the core may be prepared in the continuous stirred-tank reactor in consideration of a continuous manufacturing process and production rate.

The core preparation reactor may include an internal structure, such as an impeller and a baffle, for uniform mixing. For example, the core preparation reactor may include two or more impellers and two or more baffles therein.

For example, preparatory operations for core preparation may be performed in the core preparation reactor. For example, the core preparation reactor may be prepared by introducing deionized water and purging with an inert gas before core preparation.

According to exemplary embodiments, a core preparation aqueous solution including a metal precursor and NH₄OH may be introduced into the core preparation reactor to react. From the time the core preparation aqueous solution is introduced, the impeller and the baffle may be operated to continuously stir the solution.

The metal precursor may include precursors such as Ni, Co, Mn, Na, Mg, Ca, Ti, V, Cr, Cu, Zn, Ge, Sr, Ag Ba, Zr, Nb, Mo, Al and Ga. For example, the metal precursor may include metal sulfates, nitrides, carbonates, and the like. The metal precursor may include the precursors of the above-listed metals, either alone or in combination of two or more thereof.

The content of precursors containing different metals among the metal precursors may be adjusted in consideration of the composition of the target cathode active material.

The molar concentration of the metal precursor in the core preparation aqueous solution may be approximately 1.0 M to 2.7M.

According to exemplary embodiments, the ratio of the molar concentration of NH₄OH to the molar concentration of the metal precursor in the core preparation aqueous solution may be 0.5 to 0.8. According to some embodiments, the ratio of the molar concentration of NH₄OH to the molar concentration of the metal precursor in the core preparation aqueous solution may be 0.6 to 0.75.

Within the above range, a core having a secondary particle structure in which a plurality of primary particles are agglomerated without orientation may be prepared.

According to exemplary embodiments, the core preparation aqueous solution may further include NaOH. Accordingly, the core may be formed in an alkaline atmosphere.

According to exemplary embodiments, the ratio of the molar concentration of NaOH to the molar concentration of the metal precursor in the core preparation aqueous solution may be 1.5 to 2. According to some embodiments, the ratio of the molar concentration of NaOH to the molar concentration of the metal precursor in the core preparation aqueous solution may be 1.6 to 1.95.

Within the above range, a core having a secondary particle structure in which a plurality of primary particles are agglomerated without orientation may be prepared.

A reaction may be performed by introducing the core preparation aqueous solution into the core preparation reactor and stirring the solution. The stirring speed may vary depending on the volume of the core preparation reactor.

According to exemplary embodiments, an impeller tip speed of the core preparation reactor may be 100 m/min to 600 m/min. According to some embodiments, the impeller tip speed of the core preparation reactor may be 200 m/min to 550 m/min.

According to exemplary embodiments, the stirring speed of the core preparation reactor may be 500 rpm to 1,500 rpm. According to some embodiments, the stirring speed of the core preparation reactor may be 600 rpm to 1,200 rpm.

Within the above range, relatively small-sized cores may be formed.

According to exemplary embodiments, a temperature within the core preparation reactor may be about 40° C. to 60° C. As the temperature inside the core preparation reactor increases, a core having a smaller average particle diameter may be prepared.

According to exemplary embodiments, the core may have a median particle diameter (D50) of 1 μm to 5 μm. According to some embodiments, the median particle diameter (D50) of the core may be 2 μm to 4.5 μm. Within this range, the volume of a shell in the cathode active material precursor, which may increase battery performance, may become relatively larger, and the capacity and stability of the battery may be further improved.

A core-shell particle dispersion is prepared by dividing and introducing the core dispersion into a plurality of shell growth reactors (e.g., S1-1 and S1-2 in FIG. 1) to grow a shell from the surface of the core. This may reduce the number of core particles per unit volume within the reactor, thereby enabling more rapid growth of a first shell.

If shells are grown in a single batch reactor after the cores are prepared, shells may grow on the surfaces of an excessively large number of core particles. Accordingly, the shell growth rate and production rate may be reduced. Increasing the temperature to increase the shell growth rate may lead to side reactions. Furthermore, when a single reactor is used, a reactor having a volume greater than the combined volumes of the plurality of shell growth reactors may be needed, which may require excessively large equipment space.

The shell growth reactor may be a continuous stirred-tank reactor (CSTR) or a batch reactor (BR).

The shell growth reactor may include an internal structure, such as an impeller and a baffle, for uniform mixing. For example, the shell growth reactor may include two or more impellers and two or more baffles therein.

The core-shell particle dispersion may be prepared by dividing and introducing the core dispersion into the plurality of shell growth reactors, and introducing a shell growth aqueous solution including a metal precursor and NH₄OH to react.

The reaction time is not particularly limited and may be adjusted in consideration of the concentration of the metal precursor and the stirring speed.

The concentration of the metal precursor in the shell growth aqueous solution may be 1.0 M to 2.7 M. The metal precursor may be the same as described above for the core preparation aqueous solution.

According to exemplary embodiments, the ratio of the molar concentration of NH₄OH to the molar concentration of the metal precursor in the shell growth aqueous solution may be greater than the ratio of the molar concentration of NH₄OH to the molar concentration of the metal precursor in the core preparation aqueous solution. Accordingly, rod-shaped primary particles may grow from the surfaces of the cores as shells. Additionally, particle aggregation may be promoted, suppressing the formation of particles with small particle sizes, controlling the particle size distribution, and allowing a first shell to grow from the surfaces of the cores.

According to exemplary embodiments, the shell growth aqueous solution may further include NaOH. Accordingly, the shell may grow in an alkaline atmosphere.

The ratio of the molar concentration of NaOH to the molar concentration of the metal precursor in the shell growth aqueous solution may be less than the ratio of the molar concentration of NaOH to the molar concentration of the metal precursor in the core preparation aqueous solution. Accordingly, rod-shaped primary particles may grow as shells from the surfaces of the cores.

According to exemplary embodiments, the number of shell growth reactors may be 2 to 10. According to some embodiments, the number of shell growth reactors may be 3 to 9.

According to exemplary embodiments, the shell may be formed on the surfaces of the cores by a multi-stage reaction. For example, the core-shell particle dispersion may be prepared by dividing and introducing the core dispersion into a plurality of first shell growth reactors (S1-1, S1-2, and . . . in FIG. 1) to grow a first shell from the surface of the core, thereby preparing a first preliminary core-shell particle dispersion, and by dividing and introducing the first preliminary core-shell particle dispersion into a plurality of second shell growth reactors (S1-1, S1-2, and . . . in FIG. 1) to grow a second shell from the surfaces of the first preliminary core-shell particles.

When the shell is grown by a multi-stage reaction as described above, the shell may grow more rapidly. Consequently, a cathode active material precursor having a core-shell particle structure having a small core particle size and a thick shell may be prepared.

The first preliminary core-shell particle dispersion may be prepared by dividing and introducing the core dispersion into a plurality of first shell growth reactors, and introducing a first shell growth aqueous solution including a metal precursor and NH₄OH to react. The first shell growth reactor may correspond to the shell growth reactor, and the first shell growth aqueous solution may correspond to the shell growth aqueous solution.

According to exemplary embodiments, the first preliminary core-shell particle dispersion may be divided and introduced into a plurality of second shell growth reactors, and a second shell growth aqueous solution including a metal precursor and NH₄OH may be introduced to react.

The first preliminary core-shell particle dispersion prepared from one first shell growth reactor (e.g., S1-1 in FIG. 1) among the first shell growth reactors may be divided and introduced into a plurality of second shell growth reactors (S2-1, S2-2, and . . . in FIG. 1). For example, the number of second shell growth reactors may be at least twice the number of first shell growth reactors. For example, when the number of first shell growth reactors is three, the number of second shell growth reactors may be at least six.

The ratio of the molar concentration of NH₄OH to the molar concentration of the metal precursor in the second shell growth aqueous solution may be greater than the ratio of the molar concentration of NH₄OH to the molar concentration of the metal precursor in the first shell growth aqueous solution. Accordingly, it is possible to prevent the shell growth rate from decreasing due to excessive particle size reduction and an increase in the specific surface area of the preliminary particles.

The first shell growth aqueous solution and the second shell growth aqueous solution may each further include NaOH. This allows the shells to grow in multiple stages in an alkaline atmosphere.

The ratio of the molar concentration of NaOH to the molar concentration of the metal precursor in the second shell growth aqueous solution may be less than the ratio of the molar concentration of NaOH to the molar concentration of the metal precursor in the first shell growth aqueous solution. Accordingly, it is possible to prevent the shell growth rate from decreasing due to excessive particle size reduction and an increase in the specific surface area of the preliminary particles.

The core-shell particle dispersion may be prepared by a multi-stage reaction including three or more stages. For example, a second shell may be grown from the surfaces of the first preliminary core-shell particles to prepare a second preliminary core-shell particle dispersion, and the second preliminary core-shell particle dispersion may then be divided and introduced into a plurality of third shell growth reactors to grow a third shell.

For example, increasing the number of stages in the multi-stage reaction may reduce the reaction time for each stage. For example, a three-stage reaction may be performed for 30 minutes in each stage, allowing shells having the same thickness to be grown in a shorter period of time than a two-stage reaction performed for 1 hour in each stage.

After growing the third shell, the shell growth step may be repeated to perform a multi-stage reaction. For example, a process for growing a third shell, a process for growing a fourth shell, . . . a process for growing a tenth shell may be further performed.

The process for growing the n^{th} shell may be performed in accordance with the same principles as the process for growing the first shell described above. However, the compositions of the metal precursor, NH₄OH, and optionally NaOH may differ from the concentrations in the aqueous solutions used in the previous step.

For example, the NH₄OH content in the n^{th} aqueous solution used in the process for growing the n^{th} shell may be greater than the NH₄OH content in the (n−1)^{th} aqueous solution used in the process for growing the (n−1)^{th} shell.

For example, the NaOH content in the n^{th} aqueous solution used in the process for growing the n^{th} shell may be less than the NaOH content in the (n−1)^{th} aqueous solution used in the process for growing the (n−1)^{th} shell.

The pH of the core-shell particle dispersion may be less than 12.5. For example, the pH of the core-shell particle dispersion may be 9 or more and less than 12.5. The core-shell particles may include a metal hydroxide, and the pH may gradually decrease as hydroxide ions are co-precipitated as the metal hydroxide in an alkaline atmosphere. Accordingly, some metal precursors may remain unreacted.

According to exemplary embodiments, an aqueous NaOH solution is introduced into the core-shell particle dispersion to increase its pH to 12.5 or more. According to some embodiments, the pH of the core-shell particle dispersion may be increased to 12.5 to 13.5 by introducing an aqueous NaOH solution.

Accordingly, the metal precursor remaining in the core-shell particle dispersion may undergo additional reactions, further growing the shell, and reducing the production cost and increasing the production efficiency of the cathode active material precursor.

If the pH of the core-shell particle dispersion is not sufficiently increased to 12.5 or more, the reaction rate of the metal precursor may not increase, and the additional reaction may be minimal. Accordingly, the production rate of the cathode active material precursor may be reduced.

For example, the core-shell particle dispersion may not be colorless and transparent due to the presence of residual metal precursors. For example, the core-shell particle dispersion may exhibit a blue color.

When the pH of the core-shell particle dispersion is increased to 12.5 or more by introducing an aqueous NaOH solution, the residual metal precursors may further react to form metal hydroxides, co-precipitating and allowing the shell to grow. Accordingly, the dispersion may be colorless and transparent after the additional reaction is complete.

The cathode active material precursor according to the present disclosure includes metal hydroxide particles having a core and a shell layer disposed on the surface of the core. The ratio of the median particle diameter of the metal hydroxide particles to the median particle diameter of the core may be 1 to 4. According to some embodiments, the ratio of the median particle diameter of the metal hydroxide particles to the median particle diameter of the core may be 1.2 to 3.7, 1.5 to 3.8, or 1.7 to 3.7.

Within the above range, the volume occupied by the shell layer may be relatively larger than the volume of the core, thereby enabling a cathode active material with improved capacity and stability.

If the ratio of the median particle diameter of the metal hydroxide particles to the median particle diameter of the core is less than 1, the volume of the core among the metal hydroxide particles may increase, and the stability and capacity of the cathode active material implemented from the cathode active material precursor may deteriorate.

If the ratio of the median particle diameter of the metal hydroxide particles to the median particle diameter of the core exceeds 4, excessive production time may be required, reducing the productivity of the cathode active material.

The core may have a median particle diameter (D50) of 1 μm to 5 μm. According to some embodiments, the median particle diameter (D50) of the core may be 1.5 μm to 4.5 μm.

The core may be the same as described above. The core may have a secondary particle structure including a plurality of primary particles. For example, the core may have a secondary particle structure in which a plurality of primary particles are agglomerated without orientation.

The primary particles of the core may have a spherical, quasi-spherical, or irregular shape.

The shell layer may include the above-described first shell, or may include the first to the n^{th} shell, where n is an integer of 2 to 10.

In the shell layer, a boundary between the first shell and the n^{th} shell may not be distinct. For example, when the second shell is formed after the first shell is formed, the primary particles on the outer surface of the first shell may grow as they are, allowing the second shell growth process to be performed. Accordingly, the first shell and the n^{th} shell may be observed as a single layer without a boundary.

According to the exemplary embodiments, the shell layer may include a plurality of rod-shaped primary particles.

For example, the primary particles of the shell layer may have an aspect ratio of 2 to 10. The aspect ratio may refer to a value of the major axis length relative to the minor axis length of the particle. The primary particles may have a rod shape, such that the major axis may correspond to the longitudinal direction of the rod shape, and the minor axis may correspond to the thickness direction of the rod shape.

At least some of the primary particles may be oriented toward the center of the metal hydroxide particle. At least some of the rod-shaped primary particles may be arranged in the particle size direction of the metal hydroxide particle.

The metal hydroxide particles may have a median particle diameter of 2 μm to 30 μm. According to exemplary embodiments, the metal hydroxide particles may have a median particle diameter of 2.5 μm to 18 μm.

Within the above range, a cathode active material having an appropriate size may be provided, thereby improving the energy density of the electrode.

According to exemplary embodiments, the metal hydroxide particles may have a sphericity of 0.8 to 1. According to some embodiments, the sphericity of the metal hydroxide particles may be 0.85 to 1. The sphericity refers to the ratio of the minor axis to the major axis of the particle and may be greater than 0 and not more than 1. The closer the particle shape is to a spherical shape, the closer the sphericity may be to 1, and when the particle is spherical, the sphericity may be 1.

The metal hydroxide particles have a sphericity of 0.8 to 1, enabling the implementation of a cathode active material capable of uniformly permeating and releasing lithium ions. Consequently, the crystal structure stability of the cathode active material may be enhanced, and battery cycle life characteristics may be improved.

According to exemplary embodiments, the cathode active material precursor may include metal hydroxide particles including a core and a shell layer disposed on the surface of the core, wherein the ratio of the median particle diameter of the metal hydroxide particle to the median particle diameter of the core may be 1 to 4, and a sphericity of the metal hydroxide particle may be 0.8 to 1.

According to exemplary embodiments, a span value of the metal hydroxide particles, defined by Equation 1, may be 0.6 or less. According to some embodiments, the span value of the metal hydroxide particles, defined by Equation 1, may be 0.55 or less.

$${V}_{span} = ( D 90 - D 10 ) / D 50 \qquad [ Equation 1 ]$$

In Equation 1, Vₛₚₐₙ denotes the span value, D90 denotes the particle diameter at the 90% point of the cumulative particle size distribution of the metal hydroxide particles, D10 denotes the particle diameter at the 10% point of the cumulative particle size distribution of the metal hydroxide particles, and D50 denotes the particle diameter at the 50% point of the cumulative particle size distribution of the metal hydroxide particles.

A smaller span value may indicate a narrower cumulative particle size distribution, and the particle size distribution of the metal hydroxide particles may be more uniform.

Within the above range, problems such as changes in the crystal structure of localized regions of the electrode and subsequent battery ignition may be suppressed.

According to exemplary embodiments, the cathode active material precursor may include metal hydroxide particles including a core and a shell layer disposed on the surface of the core, wherein the ratio of the median particle diameter of the metal hydroxide particle to the median particle diameter of the core may be 1 to 4, and a span value of the metal hydroxide particles, defined by Equation 1, may be 0.6 or less.

According to exemplary embodiments, the content of nickel, based on the total molar amount of elements of the metal hydroxide particles excluding oxygen and hydrogen, may be 55 mol % to 99 mol %. According to some embodiments, the content of nickel, based on the total molar amount of elements of the metal hydroxide particles excluding oxygen and hydrogen, may be 80 mol % to 99 mol %.

According to some embodiments, the metal hydroxide particle may include a metal hydroxide represented by Formula 1 below.

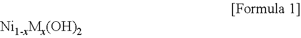

In Formula 1, x may be 0.01 to 0.35, and M may include at least one of Co, Mn, Na, Mg, Ca, Ti, V, Cr, Cu, Zn, Ge, Sr, Ag Ba, Zr, Nb, Mo, Al and Ga.

For example, in Formula 1, x may be 0.01 to 0.2.

According to the method for preparing a cathode active material of the present disclosure, after preparing a cathode active material precursor by the above-described method, the cathode active material precursor and a lithium source are mixed and calcined. The method for preparing the cathode active material may follow a known process.

For example, the cathode active material precursor and the lithium source may be dry mixed to prepare a mixture. The mixing method is not particularly limited, but may be performed by ball milling.

A molar ratio of lithium in the lithium source to a molar amount of metals in the cathode active material precursor, excluding oxygen and hydrogen, may be 0.8 to 1.2. According to some embodiments, the molar ratio of lithium in the lithium source to the molar amount of metals in the cathode active material precursor, excluding oxygen and hydrogen, may be 0.9 to 1.1.

The mixture may be calcined at a high temperature to prepare the cathode active material. For example, the calcination may be performed at a temperature of 600° C. to 1000° C., for example, 1 hour to 10 hours.

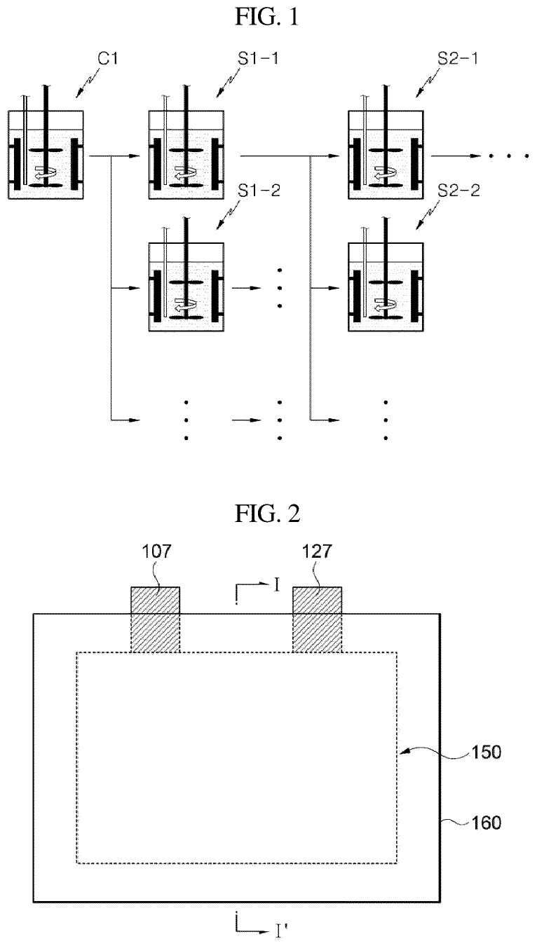

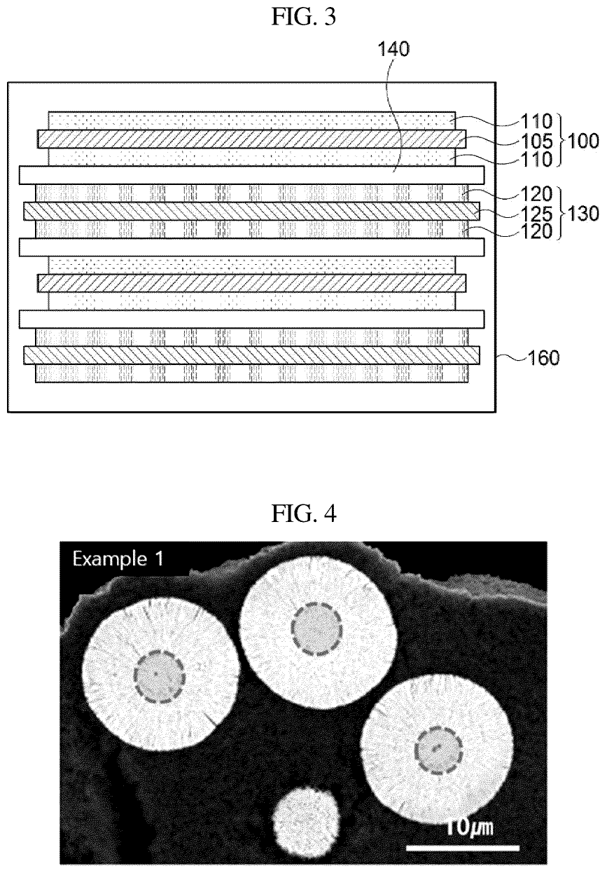

FIGS. 2 and 3 are schematic plan and cross-sectional views, respectively, illustrating a lithium secondary battery according to some embodiments. Specifically, FIG. 3 is a cross-sectional view taken along line I-I′ of FIG. 2 in the thickness direction of the lithium secondary battery.

Referring to FIGS. 2 and 3, the lithium secondary battery may include an electrode assembly 150 accommodated in a case 160. As shown in FIG. 3, the electrode assembly 150 may include a cathode 100, an anode 130 and a separator 140 that are repeatedly stacked.

The cathode 100 includes a cathode current collector 105 and a cathode active material layer 110 disposed on at least one surface of the cathode current collector 105.

The cathode current collector 105 may include stainless steel, nickel, aluminum, titanium, or an alloy thereof. The cathode current collector 105 may also include aluminum or stainless steel whose surface is treated with carbon, nickel, titanium or silver. For example, the cathode current collector 105 may have a thickness of 10 μm to 50 μm, but is not particularly limited thereto.

The cathode active material layer 110 may be disposed on both surfaces of the cathode current collector 105.

The cathode active material layer 110 may include a cathode active material. The cathode active material may include a lithium metal oxide.

The cathode active material may further include another cathode active material in addition to the lithium metal oxide. For example, the cathode active material may further include a lithium cobalt oxide-based active material, a lithium manganese oxide-based active material, or a lithium iron phosphate (LFP)-based active material (e.g., LiFePO₄).

The cathode active material layer may further include a conductive material. The conductive material compensates for the reduction in electrical conductivity of the cathode active material layer caused by the binder.

The conductive material may include, for example, carbon-based conductive materials such as graphite, carbon black, acetylene black, Ketjen black, graphene, carbon nanotubes, vapor-grown carbon fibers (VGCF), and carbon fibers; and/or metal-based conductive materials such as tin, tin oxide, and titanium oxide; as well as perovskite materials such as LaSrCoO₃, and LaSrMnO₃. For example, the conductive material may include carbon nanotubes.

The content of the conductive material based on the total weight of the cathode active material layer may be 0.01 wt % to 3 wt %. In some embodiments, the content of the conductive material based on the total weight of the cathode active material layer may be 0.1 wt % to 1 wt %.

The cathode active material layer may further include a binder. The binder may bind the cathode active material and the conductive material, and may enhance the adhesion between the cathode active material layer and the cathode current collector.

The binder may include, for example, an organic binder such as vinylidene fluoride-hexafluoropropylene copolymer (PVDF-co-HFP), polyvinylidene fluoride (PVDF), polyacrylonitrile, polymethyl methacrylate, etc., or an aqueous binder such as styrene-butadiene rubber (SBR), and may be used together with a thickener such as carboxymethyl cellulose (CMC).

For example, a PVDF-based binder may be used as a binder for forming the cathode. In this case, the amount of the binder for forming the cathode active material layer may be reduced and the amount of the cathode active material may be relatively increased, thereby improving the output and capacity of the secondary battery.

The content of the binder may be 0.5 wt % to 5 wt % based on the total weight of the cathode active material layer. In some embodiments, the content of the binder may be 1 wt % to 3 wt % based on the total weight of the cathode active material layer.

The cathode active material layer may further include a thickener and/or a dispersant. For example, the cathode active material layer may include a thickener such as carboxymethyl cellulose (CMC).

The cathode active material layer 110 may be formed from a cathode slurry composition including a cathode active material and a binder. For example, the cathode active material layer 110 may be prepared by applying the cathode slurry composition including a cathode active material and a binder to one surface of the cathode current collector 105, and then drying and roll-pressing the applied layer.

According to exemplary embodiments, the cathode slurry may include a solvent. As the solvent, N-methyl-2-pyrrolidone (NMP), dimethylformamide, dimethylacetamide, N,N-dimethylaminopropylamine, ethylene oxide, tetrahydrofuran, and the like may be used.

The application of the cathode slurry may be performed using methods such as gravure coating, slot die coating, simultaneous multilayer die coating, imprinting, doctor blade coating, dip coating, bar coating or casting, etc., but is not limited thereto.

According to exemplary embodiments, the cathode active material layer may have thickness of, for example, 10 μm to 200 μm, but is not particularly limited thereto.

According to some embodiments, the cathode active material layer may include two or more layers including different types of cathode active materials, conductive materials, and/or binders. For example, the cathode active material layer may include a first cathode active material layer and a second cathode active material layer, and the type and/or content of the active material, conductive material, and/or binder in the first cathode active material layer may be different from the type and/or content of the active material, conductive material, and/or binder in the second cathode active material layer.

The anode 130 may include an anode current collector 125 and an anode active material layer 120, which is formed by coating an anode active material on the anode current collector 125.

As the anode active material, any active material known in the art may be used, so long as it is capable of absorbing and releasing lithium ions, without particular limitation. For example, carbon-based materials such as crystalline carbon, amorphous carbon, carbon composites, carbon fibers, etc.; a lithium alloy; silicon or tin may be used. Examples of the amorphous carbon may include hard carbon, coke, mesocarbon microbead (MCMB) calcined at 1500° C. or lower, mesophase pitch-based carbon fiber (MPCF) or the like. Examples of the crystalline carbon may include graphite-based carbon such as natural graphite, graphitized coke, graphitized MCMB, graphitized MPCF or the like. Other elements contained in the lithium alloy may include, for example, aluminum, zinc, bismuth, cadmium, antimony, silicon, lead, tin, gallium, indium or the like.

The anode current collector 125 may include, for example, gold, stainless steel, nickel, aluminum, titanium, copper, or an alloy thereof, and preferably includes copper or a copper alloy.

In some embodiments, a slurry may be prepared by mixing the anode active material with a binder, a conductive material and/or a dispersant in a solvent, followed by stirring the mixture. The slurry may be coated on at least one surface of the anode current collector 125, followed by compression and drying to prepare the anode 130.

As the binder and the conductive material, materials which are substantially the same as or similar to the above-described materials used in the cathode active material layer 110 may be used. In some embodiments, a binder for forming an anode may include, for example, an aqueous binder such as styrene-butadiene rubber (SBR) to ensure compatibility with the carbon-based active material, and may be used together with a thickener such as carboxymethyl cellulose (CMC).

The separator 140 may be interposed between the cathode 100 and the anode 130. The separator 140 may include a porous polymer film made of a polyolefin polymer such as ethylene homopolymer, propylene homopolymer, ethylene/butene copolymer, ethylene/hexene copolymer, or ethylene/methacrylate copolymer. The separator 140 may include a nonwoven fabric made of glass fibers having a high melting point, polyethylene terephthalate fibers, etc.

In some embodiments, the anode 130 may have an area (e.g., a contact area with the separator 140) and/or volume greater than that of the cathode 100. Thereby, lithium ions generated from the cathode 100 may migrate smoothly to the anode 130 without being precipitated during the process, for example. Therefore, effects of simultaneously improving output and stability through a combination of a first cathode active material layer and a second cathode active material layer (not shown in the drawings) may be more easily implemented.

According to exemplary embodiments, an electrode cell is defined by the cathode 100, the anode 130, and the separator 140, and a plurality of electrode cells may be stacked to form, for example, a jelly roll type electrode assembly 150. For example, the electrode assembly 150 may be formed by winding, stacking, or folding the separator 140.

The electrode assembly 150 may be accommodated within a case 160 together with an electrolyte to define a lithium secondary battery. According to exemplary embodiments, a non-aqueous electrolyte may be used as the electrolyte.

The non-aqueous electrolyte contains a lithium salt as an electrolyte and an organic solvent, and the lithium salt may be expressed as, for example, Li⁺X⁻, and examples of the anion (X⁻) of the lithium salt include F⁻, Cl⁻, Br⁻, I⁻, NO₃⁻, N(CN)₂⁻, BF₄⁻, ClO₄⁻, PF₆⁻, (CF₃)₂PF₄⁻, (CF₃)₃PF₃⁻, (CF₃)₄PF₂⁻, (CF₃)₅PF⁻, (CF₃)₆P⁻, CF₃SO₃⁻, CF₃CF₂SO₃⁻, (CF₃SO₂)₂N⁻, (FSO₂)₂N⁻, CF₃CF₂(CF₃)₂CO⁻, (CF₃SO₂)₂CH⁻, (SF₅)₃C⁻, (CF₃SO₂)₃C⁻, CF₃(CF₂)₇SO₃⁻, CF₃CO₂⁻, CH₃CO₂⁻, SCN⁻, and (CF₃CF₂SO₂)₂N⁻.

As the organic solvent, for example, propylene carbonate (PC), ethylene carbonate (EC), diethyl carbonate (DEC), dimethyl carbonate (DMC), ethyl methyl carbonate (EMC), methyl propyl carbonate, dipropyl carbonate, dimethyl sulfoxide, acetonitrile, dimethoxyethane, diethoxyethane, vinylene carbonate, sulfolane, γ-butyrolactone, propylene sulfite and tetrahydrofuran, etc. may be used. These may be used alone or in combination of two or more thereof.

As shown in FIG. 2, electrode tabs (cathode tabs and anode tabs) protrude from the cathode current collector 105 and the anode current collector 125, respectively, which belong to respective electrode cells, and may extend to one side of the case 160. The electrode tabs may be welded together with the one side of the case 160 to form electrode leads (a cathode lead 107 and an anode lead 127) that extend or are exposed to an outside of the case 160.

FIG. 2 shows that the cathode lead 107 and the anode lead 127 protrude from an upper side of the case 160 in a planar direction, but positions of the electrode leads are not limited thereto. For example, the electrode leads may protrude from at least one of both sides of the case 160, or may protrude from a lower side of the case 160. Alternatively, the cathode lead 107 and the anode lead 127 may be formed so as to protrude from different sides of the case 160, respectively.

The lithium secondary battery may be manufactured, for example, in a cylindrical, prismatic, pouch, or coin type using a can.

Hereinafter, embodiments of the present disclosure will be further described with reference to specific experimental examples. However, the examples and comparative examples included in the experimental examples are provided merely for illustrative purposes of the present disclosure and are not intended to limit the scope of the appended claims. It will be apparent to those skilled in the art that various changes and modifications may be made within the scope and spirit of the present disclosure, and such changes and modifications are to be regarded as falling within the scope of the appended claims.

### Example 1

### Preparation of Cathode Active Material Precursor

### (1) Preparation of Core

Cores were prepared using a 50 L reactor equipped with three impellers and three baffles therein. The reactor was purged with nitrogen gas, and a core preparation aqueous solution containing a metal precursor, NH₄OH, and NaOH was added. The solution was stirred with each impeller at 700 rpm and the reaction was conducted at 50° C. The metal precursors included NiSO₄, CoSO₄, and MnSO₄ in a molar ratio of 8:1:1. The concentration of the metal precursors in the core preparation aqueous solution was 2.5 M, the ratio of the concentration of NH₄OH to the metal precursor concentration was 0.7, and the ratio of the concentration of NaOH to the metal precursor concentration was 1.7.

The core preparation aqueous solution was reacted for 13 hours to prepare a core particle dispersion.

### (2) Formation of Shell

The core particle dispersion prepared in (1) above was divided into three equal parts and introduced into three first reactors, each equipped with three impellers and three baffles therein. The reactors were purged with nitrogen gas, and a first shell growth aqueous solution was added to grow the first shell.

The concentration of the metal precursor in the first shell growth aqueous solution was 2.5 M, the ratio of the concentration of NH₄OH to the metal precursor concentration was 0.75, and the ratio of the concentration of NaOH to the metal precursor concentration was 1.65. The metal precursors included NiSO₄, CoSO₄, and MnSO₄ in a molar ratio of 8:1:1.

After the first shell growth aqueous solution was added, the reaction was performed for 8 hours.

### (3) Process of Increasing pH

After the reaction, an aqueous NaOH solution was added to each first reactor to increase the internal pH to 12.5, and the mixture was stirred and then allowed to stand for 1 hour. When the supernatant became colorless and transparent, the synthesis was terminated and the cathode active material precursor was obtained.

### Preparation of Cathode Active Material

A mixture was prepared including the cathode active material precursor and LiOH as a lithium source. The mixture was prepared such that the ratio of the moles of lithium in the lithium source to the total moles of metal in the cathode active material precursor was 1.05. The mixture was then calcined at 800° C. for 7 hours to prepare the cathode active material.

### Manufacture of Battery

The cathode active material, carbon black as a conductive material, and PVDF as a binder were mixed in a weight ratio of 93:5:2 and dispersed in N-methylpyrrolidone to prepare a slurry. The slurry was applied to one surface of an aluminum current collector (having a thickness of 20 μm), and then dried and roll-pressed to fabricate a cathode.

The anode was fabricated using a lithium metal foil having a thickness of 1.2 T.

The cathode and anode were notched to a predetermined size, stacked, and a separator (polyethylene, thickness: 13 μm) was interposed between the cathode and anode. An electrolyte was then injected to prepare a 2016-type coin cell.

As the electrolyte, a solution in which LiPF₆ was dissolved at a concentration of 1 Min a solvent mixture of ethylene carbonate and ethyl methyl carbonate at a volume ratio of 1:1 was used.

### Example 2

### Formation of Second Shell

Cores were prepared in the same manner as in Example 1 (1), and shells were grown in the same manner as in Example 1 (2), except that the composition of the metal precursor was changed to include NiSO₄, CoSO₄, and MnSO₄ in a molar ratio of 7.5:1:1.5.

The first core-shell particle dispersion from one first reactor of Example 1 (2) was divided into three equal parts and introduced into three second batch reactors equipped with three impellers and three baffles therein. The reactors were purged with nitrogen gas, and a second shell growth aqueous solution was added to grow the second shell.

The concentration of the metal precursor in the second shell growth aqueous solution was 2.5 M, the ratio of the concentration of the NH₄OH to the metal precursor concentration was 0.78, and the ratio of the concentration of the NaOH to the metal precursor concentration was 1.6.

After the second shell growth aqueous solution was added, the reaction was performed for 8 hours.

After the reaction, an aqueous NaOH solution was added to each second reactor to increase the internal pH to 12.5, and the mixture was stirred and then allowed to stand for 1 hour. When the supernatant became colorless and transparent, the synthesis was terminated and the cathode active material precursor was obtained.

A cathode active material and a battery were manufactured in the same manner as in Example 1, using the cathode active material precursor prepared as described above.

### Example 3

A cathode active material precursor, a cathode active material, and a battery were manufactured in the same manner as in Example 1, except that the composition of the metal precursor was changed to include NiSO₄, CoSO₄, and MnSO₄ in a molar ratio of 9.6:0.2:0.2, the ratio of the concentration of NH₄OH to the metal precursor concentration in the first shell growth aqueous solution was changed to 0.78, and the ratio of the concentration of NaOH to the metal precursor concentration was changed to 1.6.

### Example 4

A cathode active material precursor, a cathode active material, and a battery were manufactured in the same manner as in Example 1, except that the composition of the metal precursor was changed to include NiSO₄, CoSO₄, and MnSO₄ in a molar ratio of 9:0.5:0.5, the ratio of the concentration of NH₄OH to the metal precursor concentration in the first shell growth aqueous solution was changed to 0.72, and the ratio of the concentration of NaOH to the metal precursor concentration was changed to 1.68.

### Example 5

A cathode active material precursor, a cathode active material, and a battery were manufactured in the same manner as in Example 1, except that the composition of the metal precursor was changed to include NiSO₄, CoSO₄, and MnSO₄ in a molar ratio of 6:1:3, the ratio of the concentration of NH₄OH to the metal precursor concentration in the core preparation aqueous solution was changed to 0.3, the concentration of NaOH was changed to 2, and the stirring speed of the impeller was adjusted to 1,000 rpm.

### Comparative Example 1

A cathode active material precursor, a cathode active material, and a battery were manufactured in the same manner as in Example 1, except that the core particle dispersion was not transferred to another reactor, and the first shell was grown by introducing the first shell growth aqueous solution while purging with nitrogen gas. The stirring speed was maintained at 800 rpm.

### Comparative Example 2

A cathode active material precursor, a cathode active material, and a battery were manufactured in the same manner as in Comparative Example 1, except that the composition of the metal precursor was changed to include NiSO₄, CoSO₄, and MnSO₄ in a molar ratio of 9.6:0.2:0.2, the ratio of the concentration of NH₄OH to the metal precursor concentration in the first shell growth aqueous solution was changed to 0.78, and the ratio of the concentration of NaOH to the metal precursor concentration was changed to 1.6.

### Comparative Example 3

A cathode active material precursor, a cathode active material, and a battery were manufactured in the same manner as in Comparative Example 1, except that the composition of the metal precursor was changed to include NiSO₄, CoSO₄, and MnSO₄ in a molar ratio of 6:1:3, the ratio of the concentration of NH₄OH to the metal precursor concentration in the core preparation aqueous solution was changed to 0.3, the ratio of the concentration of NaOH to the metal precursor concentration was changed to 2, and the stirring speed of the impeller was adjusted to 1,000 rpm.

### Comparative Example 4

A cathode active material precursor, a cathode active material, and a battery were manufactured in the same manner as in Example 1, except that step (3) was not performed.

### Comparative Example 5

A cathode active material precursor, a cathode active material, and a battery were manufactured in the same manner as in Example 1, except that the pH in step (3) was increased to 11.5 by introducing NaOH.

Table 1 below shows the composition of the cathode active material precursors of the examples and comparative examples, and the ratio of the molar concentration of NH₄OH or NaOH to the molar concentration of the metal precursor in the aqueous solutions.

TABLE 1

| | Composition of | | | | | Second shell | |
|---|---|---|---|---|---|---|---|
| | cathode active material | Core preparation | | First shell growth | | growth aqueous | |
| | precursor (Ni:Co:Mn, | aqueous solution | | aqueous solution | | solution | |
| | molar ratio) | NH₄OH | NaOH | NH₄OH | NaOH | NH₄OH | NaOH |
| Example 1 | 8:1:1 | 0.7 | 1.7 | 0.75 | 1.65 | — | — |
| Example 2 | 7.5:1:1.5 | 0.7 | 1.7 | 0.75 | 1.65 | 0.78 | 1.6 |
| Example 3 | 9.6:0.2:0.2 | 0.7 | 1.7 | 0.78 | 1.6 | — | — |
| Example 4 | 9:0.5:0.5 | 0.7 | 1.7 | 0.72 | 1.68 | — | — |
| Example 5 | 6:1:3 | 0.5 | 2 | 0.75 | 1.65 | — | — |
| Comparative | 8:1:1 | 0.7 | 1.7 | 0.75 | 1.65 | — | — |
| Example 1 | | | | | | | |
| Comparative | 9.6:0.2:0.2 | 0.7 | 1.7 | 0.78 | 1.6 | — | — |
| Example 2 | | | | | | | |
| Comparative | 6:1:3 | 0.5 | 2 | 0.75 | 1.65 | — | — |
| Example 3 | | | | | | | |
| Comparative | 8:1:1 | 0.7 | 1.7 | 0.75 | 1.65 | — | — |
| Example 4 | | | | | | | |
| Comparative | 8:1:1 | 0.7 | 1.7 | 0.75 | 1.65 | — | — |
| Example 5 | | | | | | | |

### Measurement Examples

Table 2 shows the values measured and derived using the following methods for the examples and comparative examples.

### (1) Measurement of Particle Size Distribution

The particle size distribution of the cores and cathode active material precursors of the examples and comparative examples was measured using laser diffraction analysis, and the span value (V span) was calculated from the D10, D50, and D90 values according to Equation 1.

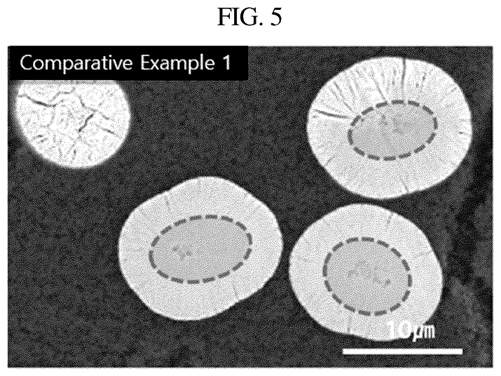

FIGS. 4 and 5 are scanning electron microscope (SEM) images of cross-sections of the cathode active material precursors of Example 1 and Comparative Example 1, respectively.

Referring to FIGS. 4 and 5, the cathode active material precursor of Comparative Example 1, prepared in a single reactor, had particle sizes similar to those of the cathode active material precursor of Example 1, which had its shell grown by a multi-stage reaction. However, the cathode active material precursor of Comparative Example 1 exhibited a larger core size (see dotted regions in FIGS. 4 and 5).

### (2) Measurement of Sphericity

SEM images were taken of the cathode active material precursors of the examples and comparative examples, and the major and minor axis lengths of 20 randomly selected particles were measured to calculate the average sphericity (minor axis length/major axis length).

### (3) Production Rate

For the cathode active material precursors of the examples and comparative examples, the amount of cathode active material produced per hour (g/hr) was calculated, and the ratio relative to the production rate of Comparative Example 1 was calculated.

TABLE 2

| | D50 (μm) | | | | |
|---|---|---|---|---|---|
| | | Metal | | | |
| | | hydroxide | | | Production |
| | Core | particles | Vₛₚₐₙ | Sphericity | rate |
| Example 1 | 4 | 13 | 0.45 | 0.88 | 1.5 |
| Example 2 | 5 | 16 | 0.31 | 0.92 | 1.7 |
| Example 3 | 5 | 17 | 0.29 | 0.94 | 1.6 |
| Example 4 | 3 | 11 | 0.51 | 0.85 | 1.65 |
| Example 5 | 2 | 3.5 | 0.43 | 0.89 | 1.3 |
| Comparative | 10 | 17 | 0.68 | 0.68 | 1 |
| Example 1 | | | | | |
| Comparative | 6 | 13 | 0.73 | 0.72 | 1.1 |
| Example 2 | | | | | |
| Comparative | 3 | 3.5 | 0.75 | 0.69 | 1.2 |
| Example 3 | | | | | |
| Comparative | 4 | 13 | 0.65 | 0.75 | 1.05 |
| Example 4 | | | | | |
| Comparative | 4 | 13 | 0.62 | 0.78 | 0.9 |
| Example 5 | | | | | |

Referring to Table 2, the cathode active material precursors prepared according to the methods of the examples exhibited high sphericity and uniform particle size. Furthermore, the methods of the examples, having improved productivity, enabled the cathode active material precursors to be produced at a higher production rate.

On the other hand, the methods of the comparative examples produced the cathode active material precursors at a lower production rate, or, even when the cathode active material precursors are produced with productivity comparable to that of the examples, resulted in degraded cathode active material quality due to uneven particle size or low sphericity.

### Experimental Example

The physical properties of the batteries of the examples and comparative examples were evaluated using the following methods, and the results are shown in Tables 3 and 4.

### (1) Evaluation of Initial Discharge Capacity and Charge-Discharge Efficiency

The batteries of the examples and comparative examples were charged under constant current conditions of 0.1 C to 4.3 V and constant voltage conditions with a 0.1 C end current, and then discharged under constant current conditions of 0.1 C to 3.0 V. The charge and discharge capacities (initial discharge capacities) at the first cycle were measured to calculate the charge and discharge efficiency.

### (2) Evaluation of Cycle Life Characteristics

The batteries of the examples and comparative examples were charged and discharged under the 1.0 C charge and 1.0 C discharge conditions at 25° C. for 100 cycles, and the discharge capacity was measured. The capacity retention was calculated as the percentage of the discharge capacity measured in Experimental Example (1) after 100 cycles.

TABLE 3

| | Initial discharge | Charge and discharge | Capacity |
|---|---|---|---|
| | capacity (mAh/g) | efficiency (%) | retention (%) |
| Example 1 | 212.7 | 92.1 | 86.2 |
| Example 2 | 208.6 | 91.8 | 90.1 |
| Example 3 | 228.3 | 91.6 | 81.3 |
| Example 4 | 219.7 | 92.5 | 84.7 |
| Comparative | 216.9 | 89.3 | 70.5 |
| Example 1 | | | |
| Comparative | 209.4 | 90.7 | 78.6 |
| Example 2 | | | |
| Comparative | 209.1 | 91.7 | 86.2 |
| Example 4 | | | |
| Comparative | 209.5 | 91.8 | 86.0 |
| Example 5 | | | |

### (3) Evaluation of High-Voltage Property

For the evaluations in (1) and (2) above, the voltage was changed to 4.45 V, and the same evaluations were conducted for Example 5 and Comparative Example 3.

TABLE 4

| | Initial discharge | Charge and discharge | Capacity |
|---|---|---|---|
| | capacity (mAh/g) | efficiency (%) | retention (%) |
| Example 5 | 200.1 | 89.9 | 80.7 |
| Comparative | 199.0 | 88.8 | 74.3 |
| Example 3 | | | |

Referring to Tables 3 and 4, the batteries of the examples exhibited improved discharge capacity, high charge and discharge efficiency, and maintained high capacity even after repeated charge and discharge cycles.

On the other hand, the batteries of the comparative examples exhibited reduced capacity or markedly degraded charge and discharge efficiency. In addition, their battery capacity significantly decreased with repeated charge and discharge cycles, resulting in substantially deteriorated cycle-life characteristics compared to those of the examples.

The contents described above are merely examples of applying the principles of the present disclosure, and other configurations may be further included without departing from the scope of the present disclosure.

### DESCRIPTION OF REFERENCE NUMERALS

100: Cathode
105: Cathode current collector
107: Cathode lead
110: Cathode active material layer
120: Anode active material layer
125: Anode current collector
127: Anode lead
130: Anode
140: Separator
150: Electrode assembly
160: Case

What is claimed is:

1. A method for preparing a cathode active material precursor, comprising: preparing a core dispersion including a core that contains a metal hydroxide;
preparing a core-shell particle dispersion by dividing and introducing the core dispersion into a plurality of shell growth reactors to grow a shell from the surface of the core; and
introducing an aqueous NaOH solution into the core-shell particle dispersion to increase its pH to 12.5 or more.

2. The method for preparing a cathode active material precursor according to claim 1, wherein the pH of the core-shell particle dispersion is increased to 12.5 to 13.5.

3. The method for preparing a cathode active material precursor according to claim 1, wherein the step of preparing the core dispersion comprises introducing a core preparation aqueous solution including a metal precursor and NH₄OH into a core preparation reactor to react.

4. The method for preparing a cathode active material precursor according to claim 3, wherein the ratio of the molar concentration of NH₄OH to the molar concentration of the metal precursor in the core preparation aqueous solution is 0.5 to 0.8.

5. The method for preparing a cathode active material precursor according to claim 3, wherein the core preparation aqueous solution further comprises NaOH, and
the ratio of the molar concentration of NaOH to the molar concentration of the metal precursor in the core preparation aqueous solution is 1.5 to 2.

6. The method for preparing a cathode active material precursor according to claim 3, wherein the step of preparing the core-shell particle dispersion comprises: dividing and introducing the core dispersion into the plurality of shell growth reactors, and introducing a shell growth aqueous solution including a metal precursor and NH₄OH to react.

7. The method for preparing a cathode active material precursor according to claim 6, wherein the ratio of the molar concentration of NH₄OH to the molar concentration of the metal precursor in the shell growth aqueous solution is greater than the ratio of the molar concentration of NH₄OH to the molar concentration of the metal precursor in the core preparation aqueous solution.

8. The method for preparing a cathode active material precursor according to claim 6, wherein the shell growth aqueous solution further comprises NaOH, and
the ratio of the molar concentration of NaOH to the molar concentration of the metal precursor in the shell growth aqueous solution is less than the ratio of the molar concentration of NaOH to the molar concentration of the metal precursor in the core preparation aqueous solution.

9. The method for preparing a cathode active material precursor according to claim 1, wherein the number of shell growth reactors is 2 to 10.

10. The method for preparing a cathode active material precursor according to claim 1, wherein the step of preparing the core-shell particle dispersion comprises:
preparing a first preliminary core-shell particle dispersion by dividing and introducing the core dispersion into a plurality of first shell growth reactors to grow a first shell from the surface of the core; and
preparing a core-shell particle dispersion by dividing and introducing the first preliminary core-shell particle dispersion into a plurality of second shell growth reactors to grow a second shell from the surfaces of the first preliminary core-shell particles.

11. The method for preparing a cathode active material precursor according to claim 10, wherein the step of preparing the first preliminary core-shell particle dispersion comprises dividing and introducing the core dispersion into a plurality of first shell growth reactors, and introducing a first shell growth aqueous solution including a metal precursor and NH₄OH to react,
the step of preparing the core-shell particle dispersion comprises dividing and introducing the first preliminary core-shell particle dispersion into a plurality of second shell growth reactors, and introducing a second shell growth aqueous solution including a metal precursor and NH₄OH to react, and
the ratio of the molar concentration of NH₄OH to the molar concentration of the metal precursor in the second shell growth aqueous solution is greater than the ratio of the molar concentration of NH₄OH to the molar concentration of the metal precursor in the first shell growth aqueous solution.

12. The method for preparing a cathode active material precursor according to claim 11, wherein the first shell growth aqueous solution and the second shell growth aqueous solution each further comprise NaOH, and
the ratio of the molar concentration of NaOH to the molar concentration of the metal precursor in the second shell growth aqueous solution is less than the ratio of the molar concentration of NaOH to the molar concentration of the metal precursor in the first shell growth aqueous solution.

13. A cathode active material precursor comprising:
metal hydroxide particles comprising a core and a shell layer disposed on the surface of the core,
wherein the ratio of the median particle diameter of the metal hydroxide particles to the median particle diameter of the core is 1 to 4, and a sphericity of the metal hydroxide particles is 0.8 to 1.

14. A cathode active material precursor comprising:
metal hydroxide particles comprising a core and a shell layer disposed on the surface of the core,
wherein the ratio of the median particle diameter of the metal hydroxide particles to the median particle diameter of the core is 1 to 4, and a span value of the metal hydroxide particles, defined by Equation 1, is 0.6 or less:
$${V}_{span} = ( D 90 - D 10 ) / D 50 \qquad [ Equation 1 ]$$
(in Equation 1, Vₛₚₐₙ denotes the span value, D90 denotes the particle diameter at the 90% point of the cumulative particle size distribution of the metal hydroxide particles, D10 denotes the particle diameter at the 10% point of the cumulative particle size distribution of the metal hydroxide particles, and D50 denotes the particle diameter at the 50% point of the cumulative particle size distribution of the metal hydroxide particles).

15. The cathode active material precursor according to claim 13, wherein the shell layer comprises a plurality of rod-shaped primary particles, and at least some of the rod-shaped primary particles are oriented toward the center of the metal hydroxide particles.

16. The cathode active material precursor according to claim 13, wherein the content of nickel, based on the total molar amount of elements of the metal hydroxide particles excluding oxygen and hydrogen, is 55 mol % to 99 mol %.

17. The cathode active material precursor according to claim 14, wherein the shell layer comprises a plurality of rod-shaped primary particles, and at least some of the rod-shaped primary particles are oriented toward the center of the metal hydroxide particles.

18. The cathode active material precursor according to claim 14, wherein the content of nickel, based on the total molar amount of elements of the metal hydroxide particles excluding oxygen and hydrogen, is 55 mol % to 99 mol %.
